(19) United States
(12) Patent Application Publication
(10) Pub. No.: US 2009/0245057 A1
(43) Pub. Date: Oct. 1, 2009

(54) SENSOR DETACHMENT DETECTION CIRCUIT, SENSOR DETACHMENT DETECTION METHOD, AND INFORMATION STORAGE DEVICE

(75) Inventors: Susumu YOSHIDA, Kawasaki (JP); Tatsurou SASAMOTO, Kawasaki (JP); Isamu TOMITA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/411,708

(22) Filed: Mar. 26, 2009

(30) Foreign Application Priority Data
Mar. 27, 2008 (JP) 2008-083918

(51) Int. Cl. G11B 20/18

(52) U.S. Cl. 369/53.42; G9B/20.046

(57) ABSTRACT

A fault detection circuit, for detecting a fault condition associated with a sensor (wherein non-fault detection signals output by the sensor include high frequency noise components), includes: an input unit to receive a raw signal from the sensor and to provide a corresponding detection signal; and a determination unit to determine if the detection signal includes components in significant amounts corresponding to the non-fault high frequency noise components, and to output an indication that the fault condition is satisfied if the detection signal does not include components in significant amounts corresponding to the non-fault high frequency noise components.

### CROSS-REFERENCE TO RELATED APPLICATION

This application is based upon and claims the benefit of priority from the prior Japanese Patent Application No. 2008-83918 filed on Mar. 27, 2008, the entire contents of which are incorporated herein by reference.

### BACKGROUND

1. Field

The embodiment discussed herein is related to detection of a sensor detachment.

2. Description of Related Art

In the current society, a variety of electronic devices have been developed with the progress of the industrial technology, and there are multiplicities of electronic devices having complicated structures. In particular, recently, technologies related to devices incorporated in computers and devices externally connected to computers have rapidly been developing with the development of the computer technology, and among these peripheral devices, there are a multiplicity of electronic devices that are complicated in structure and require complicated controls in operation.

Electronic devices are quite frequently disposed in an environment vulnerable to external shocks, and some electronic devices are provided with a sensor that detects the acceleration associated with a shock so that they can operate normally even in an environment vulnerable to external shocks. For example, among hard disk devices (HDDs) which are a kind of computer peripheral devices, an HDD is known that incorporates two acceleration sensors for detecting external shakes (for example, see Patent Reference 1, namely Japanese Laid-Open Patent Publication No. 2006-221806).

Generally, in HDDs, information recording onto the magnetic disk and information reproduction from the magnetic disk (hereinafter, recording and reproduction of information will collectively be called access) are performed by moving a head that plays a role of recording and reproducing information onto and from the magnetic disk, close to the surface of the magnetic disk while rotating the magnetic disk. At this time, positioning the head on the magnetic disk with high accuracy is important in executing highly accurate access.

In the HDD of Patent Reference 1 and HDDs incorporating two acceleration sensors, the shake that acts to rotate the HDD is detected based on the difference between the accelerations detected by the two acceleration sensors. Then, head driving control is performed so that the influence of the shake is canceled out. Now, a conventional shake detection performed in the HDD of Patent Reference 1 will be described.

FIG. 1 is a block diagram illustrating a mechanism for detecting the shake that the HDD is given in the conventional HDD incorporating two acceleration sensors.

In the conventional HDD incorporating two acceleration sensors, two acceleration sensors of a first acceleration sensor 59a and a second acceleration sensor 59b are provided on a control board (not shown in FIG. 1) that the HDD has. These acceleration sensors detect the acceleration of the control board caused by the control board given a shake, and output a signal of a voltage representative of the acceleration (hereinafter, referred to as detection signal).

The detection signal outputted from the first acceleration sensor 59a is inputted to a first filter 60a, and a low frequency component is removed therefrom in order to reduce low frequency noise. The detection signal having its low frequency component removed is then inputted to a first amplifier 61a and amplified. The detection signal amplified by the first amplifier 61a is inputted to a first analog-to-digital converter (ADC) 62a and converted from an analog signal to a digital signal. On the other hand, the detection signal representative of the acceleration detected by the second acceleration sensor 59b has its low frequency component removed by a second filter 60b, is amplified by a second amplifier 61b, and is then converted from an analog signal to a digital signal by a second ADC 62b. As a concrete circuit arrangement of the first filter 60a and the second filter 60b, for example, a circuit described in Patent Reference 2 (namely, Japanese Laid-Open Patent Publication No. 2001-326548) is adopted.

The detection signal converted to a digital signal by the first ADC 62a and the detection signal converted to a digital signal by the second ADC 62b are inputted to a micro processing unit (MPU) 570′. The MPU 570′ operates as a differentiator 571 to calculate the difference between the two kinds of detection signals. Then, the MPU 570′ operates as a gain adjuster 572 to amplify the difference. By a control value based on the amplified difference, a voice coil motor (VCM) 54 that plays a role of moving a head 51 is driven by a VCM driver 541, thereby adjusting the head position so that the influence of the shake is compensated for.

Generally, in a circuit that converts an analog detection signal obtained by an acceleration sensor, to a digital signal by an ADC, unless a device on the circuit is faulty, the average value of the detection signal (hereinafter, referred to as measurement median value) substantially coincides with the reference value of the logical signal value of the ADC (hereinafter, referred to as logical median value) under circumstances where no external force such as a shake is exerted. Therefore, in such a circuit, whether the circuit is in the normal condition or not is frequently determined by comparing the measurement median value with the logical median value.

FIG. 1 illustrates, by a block diagram, the function of the MPU 570′ of checking whether the shake detection mechanism is normally functioning or not by comparing the measurement median value with the logical median value. The check of whether the shake detection mechanism is normally functioning or not is performed with the HDD connected to a non-illustrated test system before the HDD is shipped. In this check, shake detection is performed a predetermined number of times at predetermined time intervals by the first acceleration sensor 59a and the second acceleration sensor 59b, and the predetermined number of times of detection signals are generated by the first acceleration sensor 59a and the second acceleration sensor 59b. The predetermined numbers of times of detection signals generated by the first acceleration sensor 59a are sent to the first ADC 62a through the first filter 60a and the first amplifier 61a. The MPU 570′ operates as a first average calculator 573a to obtain the measurement median value by averaging the predetermined number of times of detection signals digitized by the first ADC 62a.

On the other hand, the predetermined numbers of times of detection signals generated by the second acceleration sensor 59b undergo the second filter 60b and the second amplifier 61b, and are digitized by the second ADC 62b. Then, the MPU 570′ operates as a second average calculator 573b to obtain the measurement median value by averaging the signals.

FIG. 2 is a graph illustrating the signal values of the predetermined number of times of detection signals and the average value of the signal values.

FIG. 2 graphically illustrates the behavior of the ADC value of the detection signal in each detection when the horizontal axis represents the number of times of shake detection and the vertical axis represents the signal value (ADC value) of the detection signal digitized by the first ADC 62a. FIG. 2 also illustrates the measurement median value calculated by the first average calculator 573a. While the graph of the ADC value of the detection signal digitized by the first ADC 62a and the measurement median value are shown in the figure as an example, the graph of the ADC value of the detection signal digitized by the second ADC 62b and the measurement median value are similar thereto.

For the measurement median value calculated by a first average calculator 573a, the MPU 570′ operates as a first determiner 577a′ to determine whether the difference between the measurement median value and the logical median value is within a predetermined range or not. FIG. 2 illustrates the difference Δ between the measurement median value and the logical median value, and the first determiner 577a′ determines whether the difference Δ is within the predetermined range or not. On the other hand, the MPU 570′ also operates as a second determiner 577b′ to obtain the difference between the measurement median value calculated by the second average calculator 573b and the logical median value and determine whether the difference is within the predetermined range or not.

When any of the determination result of the first determiner 577a′ and the determination result of the second determiner 577b′ indicates that the difference between the measurement median value and the logical median value is not within the predetermined range, the above-mentioned test system is informed that abnormality is occurring in the shake detection mechanism of the HDD. Then, it is determined that the HDD is faulty, and an action such as repair is taken on the HDD.

### SUMMARY

An aspect of an embodiment of the present invention provides a fault detection circuit, for detecting a fault condition associated with a sensor (wherein non-fault detection signals output by the sensor include high frequency noise components). Such a fault detection circuit may include: an input unit to receive a raw signal from the sensor and to provide a corresponding detection signal; and a determination unit to determine if the detection signal includes components in significant amounts corresponding to the non-fault high frequency noise components, and to output an indication that the fault condition is satisfied if the detection signal does not include components in significant amounts corresponding to the non-fault high frequency noise components.

It is to be understood that both foregoing general descriptions and the following detailed description are exemplary and explanatory and are not restrictive of invention, as claimed.

### BRIEF DESCRIPTION OF THE DRAWINGS

FIG. 1 is a block diagram illustrating the mechanism for detecting the shake that the HDD is given in the conventional HDD incorporating two acceleration sensors;

FIG. 2 is a graph illustrating detection signals and the average value of the signal values;

FIG. 3 is a plan view illustrating an HDD which is a concrete embodiment of an information storage device;

FIG. 4 is a block diagram illustrating a mechanism for detecting a shake that the HDD is given in the HDD of FIG. 3;

FIG. 5 is a block diagram illustrating a manner in which the detachment of acceleration sensors is checked;

FIG. 6 is a graph illustrating the absolute values of a predetermined number of times of differences; and

FIG. 7 is a graph illustrating a graph of an integrated value in the condition where the first acceleration sensor is attached to a control board and a graph of an integrated value in the condition where the first acceleration sensor is detached from the control board of FIG. 3 in the acceleration sensor detachment detection mechanism shown in FIG. 4.

### DETAILED DESCRIPTION OF THE EXAMPLE EMBODIMENTS

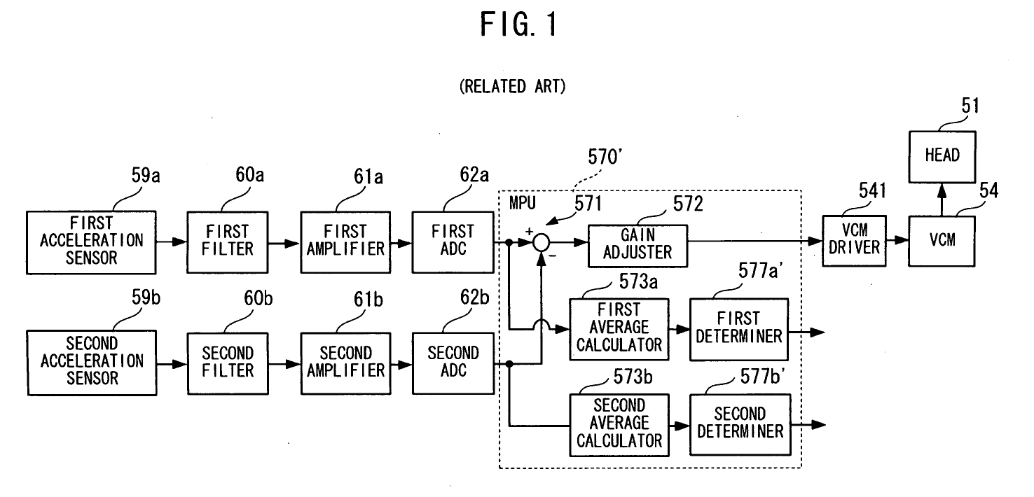

As part of assessing the Related Art, the present inventors recognized the following. In conventional HDDs having acceleration sensors, there are problematic situations where an acceleration sensor remains attached to the control board and yet is operatively disconnected from the MPU 570′, or the acceleration sensor becomes detached from the control board and yet remains operatively connected to the MPU 570′, or the acceleration sensor becomes detached from the control board and operatively disconnected from the MPU 570′. In the shake detection mechanism of the conventional HDD shown in FIG. 1, in the noted problematic situations, the resultant detection signals tend to exhibit substantially the same average as detection signals obtained from an acceleration sensor that is attached to the control board but for which the HDD is not being shaken; this is a problem. For this reason, by the conventional method comparing the measurement median value with the logical median value, the conditions where there is no shake and where an acceleration sensor is detached from the control board are difficult if not impossible to distinguish from each other, which is a problem. Moreover, in a conventional HDD in which an acceleration sensor is detached from the control board and consequently accurate shake detection is unlikely if not impossible, the access accuracy while being shaken is low, which is a problem.

Though such problems have been discussed in the context of the noted conventional HDD incorporating two acceleration, the above-mentioned problem can arise with all kinds of electronic devices having a circuit that converts an analog detection signal obtained by an acceleration sensor, to a digital signal by an ADC. Further, the above-mentioned problem can arise not only with electronic devices having an acceleration sensor but also with all kinds of electronic devices having a sensor that performs sensing and generates a detection signal such as a distortion sensor.

In view of the above-mentioned circumstances, at least some examples of an embodiment of the present invention provide the following: a sensor attachment detection circuit and a sensor attachment detection method for accurately detecting the attachment of a sensor; and an information storage device having such a sensor attachment detection circuit and being suitable for the execution of highly accurate access.

Hereinafter, an embodiment of the sensor connection detection circuit, the sensor connection detection method, and the information storage device will be described. The embodiment of the information storage device described below is an HDD incorporating two acceleration sensors.

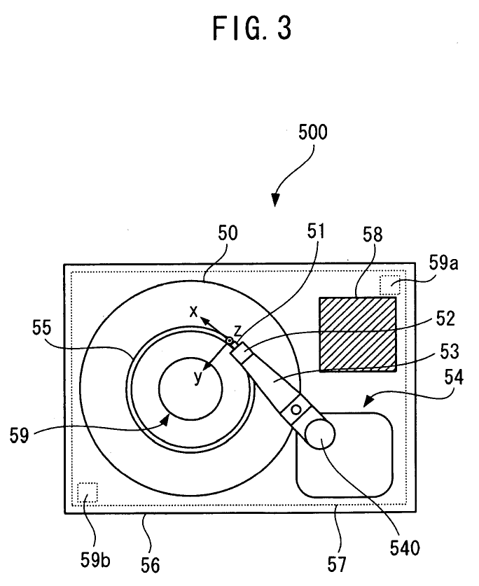

FIG. 3 is a plane view illustrating an HDD 500 which is a concrete embodiment of the information storage device.

The HDD 500 shown in FIG. 3 is provided with a voice coil motor 54 that generates a force to drive a rotation about a shaft 540. Receiving the rotation driving force, an arm 53 rotates about the shaft 540. To an end of the arm 53, a slider 52 is attached by a support member called a gimbal, and to an end of the slider 52, a head 51 is attached.

The head 51 bears a role of reading information from a magnetic disk 50 and writing information onto the magnetic disk 50. When information is read or written, the arm 53 is rotated about the voice coil motor 54 by the voice coil motor 54, whereby the head 51 is situated in a desired position on the surface of the magnetic disk 50. The head 51 at this time is held in a position at a minute height over the surface of the disk-form magnetic disk 50, and under this condition, the head 51 performs information reading from the magnetic disk 50 and information writing onto the magnetic disk 50 (hereinafter, recording and reproduction of information will collectively be called access). In this figure, the head 51 is shown in an xyz rectangular coordinate system defined such that the position of the head 51 is the origin point, the direction toward the center of the magnetic disk 50 is the y axis and the direction of the normal perpendicular to the plane of the figure is the z axis.

On the surface of the disk-form magnetic disk 50, a structure is provided in which a plurality of belt-shaped tracks running around the disk center are arranged in the radial direction, and in FIG. 3, one track 55 of these tracks is shown. In the track 55, an information storage area for storing information is provided in the direction in which the track 55 extends. The HDD 500 of FIG. 3 adopts the vertical magnetic recording method, and in the information storage area, magnetizations in the positive or negative direction of the z axis of FIG. 3 are aligned, and one bit of information is represented by such two directions. The magnetic disk 50 rotates about the disk center within the plane of FIG. 3 by receiving the rotation driving force from a spindle motor 59, and the head 51 situated close to the surface of the magnetic disk 50 becomes close to the magnetizations aligned along the track 55 of the rotating magnetic disk 50 in succession.

The head 51 is provided with a magneto resistance effect film whose electric resistance value varies according to the direction of the applied magnetic field. When information is reproduced, the head 51 retrieves the information represented by the direction of the magnetization by detecting that the value of the current flowing through the magneto resistance effect film varies according to the direction of the magnetic field caused by the magnetization. The signal representative of the current change is the reproduction signal representative of the retrieved information, and the reproduction signal is outputted to a head amplifier 58. The head 51 is also provided with a coil functioning as an electromagnet and magnetic poles. When information is recorded, an electric recording signal representing information as a bit value is inputted to the head 51 becoming close to the magnetic disk 50, through the head amplifier 58, and the head 51 allows current in the direction corresponding to the bit value of the recording signal to flow through the coil. By this current, the magnetic field caused in the coil is applied to the magnetizations on the magnetic disk through the magnetic poles, whereby the directions of the magnetizations are aligned in the direction corresponding to the bit value of the recording signal. Thereby, the information carried by the recording signal is recorded in the format of the magnetization direction.

The above-mentioned parts that are directly involved in information recording and reproduction such as the voice coil motor 54, the arm 53, the slider 52, the head 51, and the head amplifier 58 are accommodated in a base 56 together with the magnetic disk 50, and FIG. 3 illustrates the condition of the inside of the base 56. On the rear side of the base 56, a control board 57 is provided that has a control circuit for controlling the driving of the voice coil motor 54 and the access by the head 51. In FIG. 3, the control board 57 is shown by a dotted line. In the HDD 500, the whole of the parts on the surface of the base 56 and the control board 57 on the rear side of the base 56 are accommodated in a casing not shown in the figure. The above-mentioned parts are electrically connected to the control board 57 by a non-illustrated mechanism, the above-described recording signal to be inputted to the head 51 and the above-described reproduction signal generated by the head 51 are processed by the control board 57 through the head amplifier 58, and the control of the positioning of the head 51 on the magnetic disk 50 at the time of access is also performed by the control board 57. The control board 57 is provided with a later-described micro processing unit (MPU) that controls the positioning of the head 51. Further, as shown in FIG. 3, the control board 57 is provided with two acceleration sensors of a first acceleration sensor 59a and a second acceleration sensor 59b in corners of the control board 57. These acceleration sensors detect the acceleration of the control board caused by the control board given a shake, and output a signal of a voltage representative of the acceleration (hereinafter, referred to as detection signal). In the HDD 500, a shake that acts to rotate the HDD within the plane of FIG. 3 is detected based on the difference between the accelerations detected by the two acceleration sensors.

Next, the shake detection performed in the HDD 500 will be described.

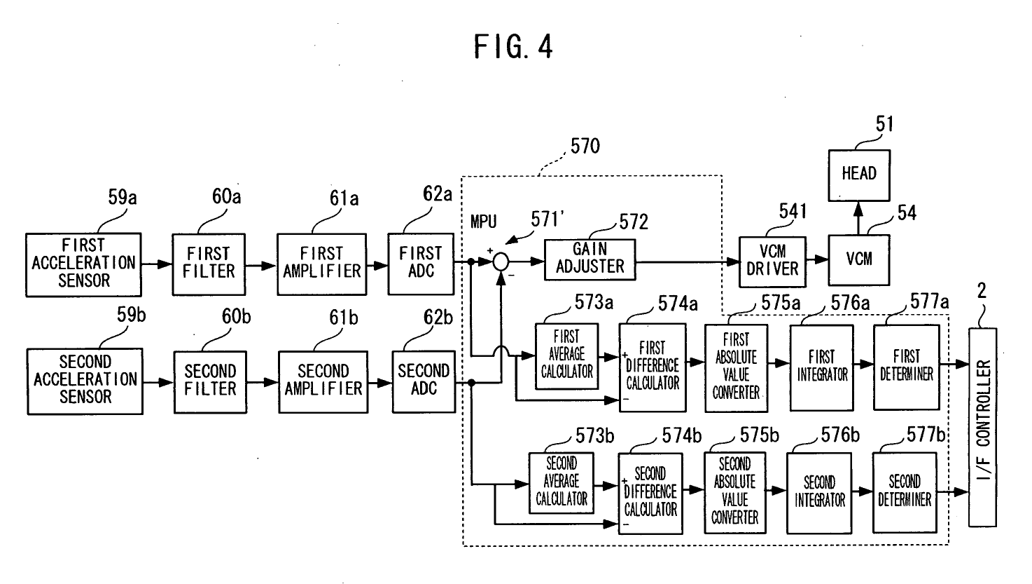

FIG. 4 is a block diagram illustrating a mechanism for detecting a shake that the HDD is given in the HDD 500 of FIG. 3.

In FIG. 4, members the same as those of the conventional HDD shown in FIG. 1 are denoted by the same reference numerals. Like the conventional HDD shown in FIG. 1, the HDD 500 of FIG. 3 is provided with the first filter 60a, the first amplifier 61a, the first ADC 62a, the second filter 60b, the second amplifier 61b, and the second ADC 62b, and the acceleration detection signals are processed in a manner similar to that of the conventional HDD shown in FIG. 1. That is, in the HDD 500 of FIG. 3, the detection signal outputted from the first acceleration sensor 59a of FIG. 4 is inputted to the first filter 60a, has its low frequency component removed therefrom in order to reduce low frequency noise, and is amplified by the first amplifier 61a after the removal of the low frequency component. The detection signal amplified by the first amplifier 61a is inputted to the first ADC 62a, and converted from an analog signal to a digital signal. On the other hand, the detection signal representative of the acceleration detected by the second acceleration sensor 59b is similarly processed by the second filter 60b and the second amplifier 61b, and converted from an analog signal to a digital signal by the second ADC 62b. As a concrete circuit arrangement of the first filter 60a and the second filter 60b, for example, the circuit described in Patent Reference 2 is adopted.

The detection signal converted to a digital signal by the first ADC 62a and the detection signal converted to a digital signal by the second ADC 62b are inputted to the MPU 570. The MPU 570 operates as a differentiator 571′ to calculate the difference between the two kinds of detection signals, and then, operates as the gain adjuster 572 to amplify the difference. Then, by a control value based on the amplified difference, the VCM 54 is driven by the VCM driver 541, thereby adjusting the position of the head 51 so that the influence of the shake is reduced if not substantially fully compensated.

Generally, in an HDD in which a shake that the HDD is given is detected by acceleration sensors attached to a control board as in the HDD 500 shown in FIG. 3, there are cases where an acceleration sensor is detached from the control board for a reason such that the attachment to the control board is insufficient.

In the HDD 500 shown in FIG. 3, in order to detect such faulty connection and/or attachment of an acceleration sensor, whether the two acceleration sensors 59a and 59b shown in FIG. 3 are attached and connected to the control board 57 or not is checked before the HDD 500 is shipped.

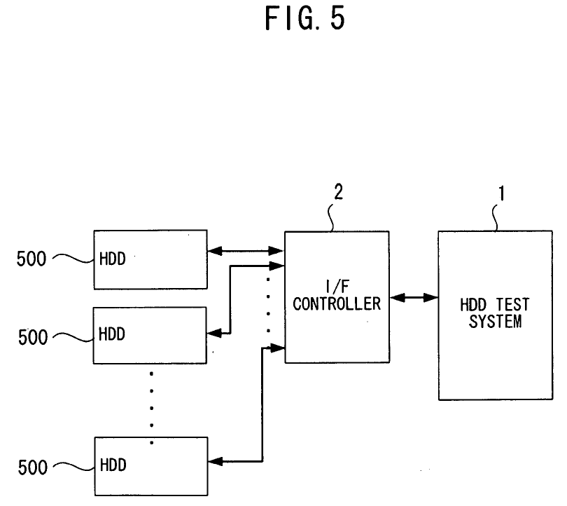

FIG. 5 is a block diagram illustrating a manner in which the attachment of the acceleration sensors is checked.

As shown in this figure, when the attachment and connection of the acceleration sensors is checked, a plurality of HDDs 500 are each connected to an I/F controller 2. As described below, each HDD 500 is provided with a mechanism for detecting whether the two acceleration sensors 59a and 59b shown in FIG. 3 in each HDD 500 are attached and connected to the control board 57 or not, and in this fault condition detection, of the plurality of HDDs 500, the HDD 500 in which a faulty attachment/connection of an acceleration sensor occurs sends a signal providing notification of the faulty attachment/connection of the acceleration sensor to the IF controller 2. The signal providing notification of the faulty attachment/connection of the acceleration sensor is sent to an HDD test system 1 connected to the I/F controller 2, and the HDD test system 1 records the HDD 500 as an HDD with a faultily attached/connected acceleration sensor. On the HDD 500 recorded as a faulty HDD, a repair for re-connecting the acceleration sensor is performed.

Next, the mechanism for detecting the attachment/connection of the two acceleration sensors, provided in the HDD 500 will be described.

When the attachment/connection of the acceleration sensors is checked, shake detection is performed a desired number of times at desired time intervals by the first acceleration sensor 59a and the second acceleration sensor 59b, thereby providing a corresponding number of detection signals, respectively. The detection signals generated by the first acceleration sensor 59a are sent to the first ADC 62a through the first filter 60a and the first amplifier 61a and digitized. On the other hand, the detection signals generated by the second acceleration sensor 59b undergo the second filter 60b and the second amplifier 61b, and are digitized by the second ADC 62b.

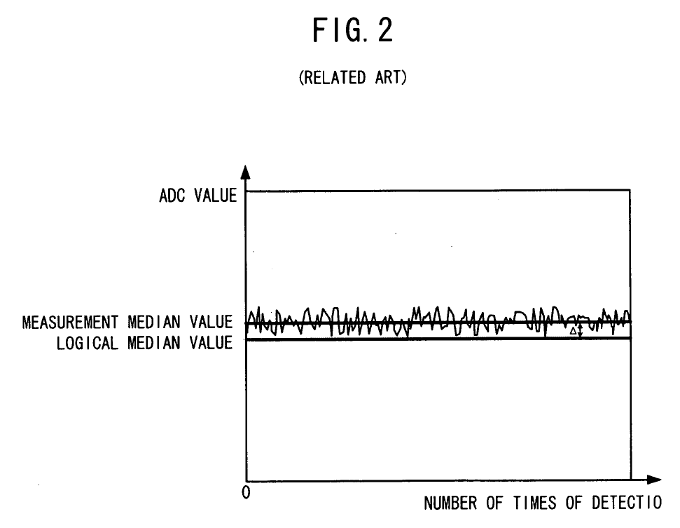

The MPU 570 operates as the first average calculator 573a and the second average calculator 573b to obtain the measurement median value by averaging the detection signals digitized by the first ADC 62a and the second ADC 62b in a manner similar to that described with reference to FIG. 2.

Further, the MPU 570 operates as a third filter to pass the high frequency components of the digitized detection signals, e.g., via a first difference calculator 574a to obtain the difference between the ADC values digitized by the first ADC 62a and the measurement median value. Then, the MPU 570 operates as a first absolute value converter 575a to convert the difference to the absolute value of the difference. When the absolute value A(n) of the difference is expressed by the following expression, the ADC value obtained in the n-th detection is Xn and the measurement median value is C:

A(n)=|Xn−C| (1)

By the first difference calculator 574a and the first absolute value converter 575a, the absolute values representing a desired number of differences are obtained in correspondence with the desired number of ADC values.

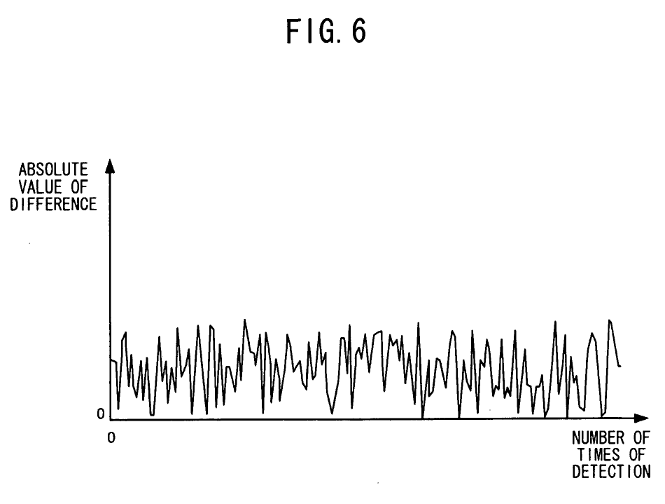

FIG. 6 is a graph illustrating the absolute values of the such differences.

FIG. 6 graphically illustrates the behavior of the absolute value of the difference in each detection when the horizontal axis represents the number of times of detection of a shake and the vertical axis represents the absolute value of the difference. That is, this is a graph expressing the absolute value A(n) of the difference expressed by the expression (1) as a function of n.

Returning to FIG. 4, description will be continued.

Then, the MPU 570 operates as a first integrator 576a to obtain the sum of the absolute values of differences obtained by the first absolute value converter 575a. That is, when the desired number of times is N, the absolute values A(n) of the differences expressed by the expression (1) are added up from n=1 to n=N, thereby obtaining the sum S(N) of the absolute values of the desired number of times of differences expressed by the following expression (2):

S(N)=A(1)+A(2)+A(3) . . . A(n) (2)

Generally, in the detection signals generated by acceleration sensors that are attached/connected to the control board, a considerable amount of noise is present even in an environment where there is no shake, and even if filters that reduce the noise of the low frequency component like the first filter 60a and the second filter 60b of FIG. 4 are used, a certain amount of noise of the high frequency component is left in the detection signals. On the other hand, when an acceleration sensor is detached and/or disconnected from the control board, such noise of the high frequency component is absent in the signal inputted to the ADC. Since the ADC values of such noise of the high frequency component are substantially zero when averaged, by the conventional method comparing the measurement median value with the logical median value described with reference to Related Art FIG. 1, the conditions where there is no shake and where an acceleration sensor is detached and/or disconnected from the control board are difficult if not impossible to distinguish from each other.

On the other hand, in the integrated value of the absolute values of the differences between the ADC values of the detection signals containing the noise of the high frequency component and the measurement median value in each detection, the influence of noise is left without being eliminated, and the integrated value significantly differs between in the condition where there is no shake and in the condition where an acceleration sensor is detached and/or disconnected from the control board.

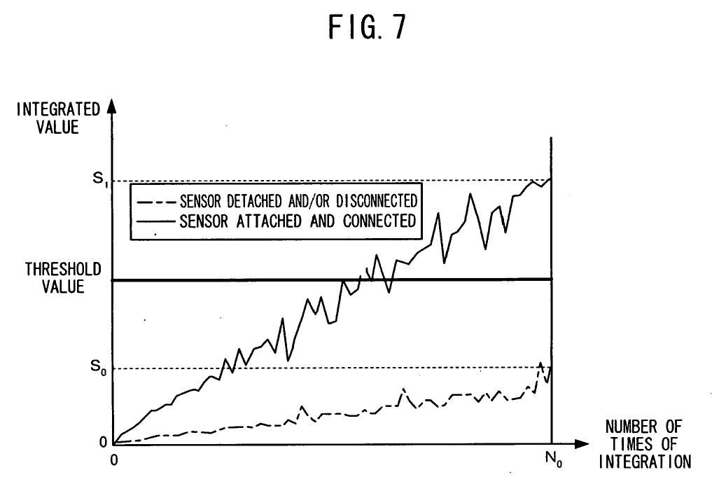

FIG. 7 is a graph illustrating a graph of the integrated value in the condition where the first acceleration sensor 59a is attached and connected to the control board 57 and a graph of the integrated value in the condition where the first acceleration sensor 59a is detached and/or disconnected from the control board 57 of FIG. 3 in the acceleration sensor fault condition detection mechanism shown in FIG. 4.

FIG. 7 illustrates the result of a test in which the integrated value S(N) of the absolute values of the differences between the ADC values of the detection signals and the measurement median value is obtained, while the desired number of times (the number of times of integration) N is changed, by performing the above-described shake detection by the first acceleration sensor 59a the desired number N of times in the condition where there is no shake given to the HDD 500 of FIG. 3. In FIG. 7, the graph of the integrated value in the condition where the first acceleration sensor 59a is attached and connected to the control board 57 is shown by a solid line, whereas the graph of the integrated value in the condition where the first acceleration sensor 59a is detached and/or disconnected from the control board 57 of FIG. 3 is shown by alternate long and short dashed lines. As shown in this figure, it is apparent that in the graph of the integrated value in the condition where the first acceleration sensor 59a is attached and connected to the control board 57, the integrated value rapidly increases as the number of times of integration increases compared with in the graph of the integrated value in the condition where the first acceleration sensor 59a is detached and/or disconnected from the control board 57 of FIG. 3. This is because when the noise of the high frequency component is contained in the detection signal, the contribution of the noise is also integrated.

In the acceleration sensor fault condition detection mechanism shown in FIG. 4, the MPU 570 operates as a comparator, e.g., as a first determiner 577a, to compare the sum S(N0) of the absolute values of the differences when the desired number of times N is N0, with a desired threshold value. Based on this comparison, when the sum S(N0) of the absolute values of the differences is equal to or greater than the threshold value, it is determined that the first acceleration sensor 59a is attached and connected to the control board 57, and when the sum S of the absolute values of the differences is smaller than the threshold value, it is determined that the first acceleration sensor 59a is detached and/or disconnected from the control board 57. For example, in FIG. 7, in the graph of the solid line, the sum of the absolute values of the differences when the number of times of integration is N0 is S1, which is greater than the threshold value in the figure. Consequently, it is determined that the first acceleration sensor 59a is attached and connected to the control board 57. On the other hand, in the graph of the alternate long and short dashed lines, the sum of the absolute values of the differences when the number of times of integration N0 is SO, which is smaller than the threshold value in the figure. Consequently, it is determined that the first acceleration sensor 59a is detached and/or disconnected from the control board 57.

While the operations of the first difference calculator 574a, the first absolute value converter 575a, the first integrator 576a, and the first determiner 577a are described above, in the acceleration sensor fault condition detection mechanism shown in FIG. 4, the MPU 570 also operates as a fourth filter to pass the high frequency components of the digitized detection signals, e.g., via a second difference calculator 574b, a second absolute value converter 575b, a second integrator 576b, and a comparator (e.g., a first determiner 577b) for detecting the detachment and/or disconnection of the second acceleration sensor 59b, and these elements perform functions similar to those of the above-described first difference calculator 574a, first absolute value converter 575a, first integrator 576a, and first determiner 577a on the detected desired number of times of detection signals generated by the second acceleration sensor 59b.

The determination results of the first determiner 577a and the second determiner 577b are inputted to the I/F controller 2 shown in FIGS. 2 and 4. The determination results are further sent to the HDD test system 1 of FIG. 5 connected to the I/F controller 2. The HDD test system 1 records the HDD 500 as an HDD 500 with a faultily attached and/or connected acceleration sensor, and a repair for re-connecting the acceleration sensor is performed on the recorded HDD 500.

As described above, in the HDD 50 shown in FIG. 2, the presence or absence of the attachment and connection of the acceleration sensors is detected by checking whether the noise of the high frequency component is contained in the detection signals or not, and even if an acceleration sensor is detached and/or disconnected, the connection condition is improved in a stage prior to the shipment of the HDD 500. Consequently, when the HDD 500 is actually used, the positioning of the head on the magnetic disk is highly accurately performed, so that highly accurate access is realized.

The above is the description of the embodiment.

While the absolute values of the differences between the ADC values and the measurement median value are integrated in the above description, in the sensor fault condition detection circuit described in the basic mode, a quantity serving as the index of the magnitude of the difference between the ADC value and the measurement median value, such as the square or the fourth power of the difference between the ADC value and the measurement median value, may be integrated.

While the desired number of times when the measurement median value of the ADC values is obtained and the number of times of integration may be the same in the above description, in the sensor fault condition detection circuit described in the basic mode, a structure may be adopted in which the number of times of detection for obtaining the measurement median value of the ADC values is increased in order to increase the accuracy of the measurement median value and the number of times of integration is decreased in order to speed the integration processing.

The discussion provided above concerns examples of an embodiment of the present. However, the present invention is not limited to this but various modifications can be made without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the examples of an embodiment of the present inventions have been described in detail, it should be understood that the various changes, substitutions, and alterations could be made hereto without departing from the spirit and scope of the invention.

What is claimed is:

1. A fault detection circuit to detect a fault condition associated with a sensor, wherein non-fault detection signals output by the sensor include high frequency noise components, the circuit comprising:
an input unit to receive a raw signal from the sensor and to provide a corresponding detection signal; and
a determination unit to determine if the detection signal includes components in significant amounts corresponding to the non-fault high frequency noise components, and to output an indication that the fault condition is satisfied if the detection signal does not include components in significant amounts corresponding to the non-fault high frequency noise components.

2. The fault detection circuit according to claim 1,
wherein the sensor is an acceleration sensor.

3. The fault detection according to claim 1, wherein the determination unit includes:
a high pass filter to filter the detection signal over a range corresponding to the non-fault high frequency noise components in order to produce a filtered signal; and
a comparator to check if content of the filtered signal exceeds a threshold value, and to output the indication that the fault condition is satisfied if the content of the filtered signal exceeds a threshold value.

4. The fault detection according to claim 3, wherein the determination unit further includes:
an integrator to integrate the filtered signal to produce an integrated signal;
wherein the comparator is further operable to compare the integrated signal with the threshold value.

5. The fault detection according to claim 3, wherein the determination unit includes:
an absolute value converter to convert the filtered signal into an absolute value signal; and
an integrator to integrate the filtered signal to produce an integrated signal;
wherein the comparator is further operable to compare the integrated signal with the threshold value.

6. The fault detection according to claim 3, wherein the high pass filter includes:
an averaging unit to average the detection signal thereby producing an averaged signal; and
a difference unit to take a difference between the averaged signal and the detection signal to obtain the filtered signal.

7. The sensor fault detection circuit according to claim 6,
wherein the averaged signal represents a median value of the detection signal.

8. A sensor fault condition detection method comprising:
inputting a detection signal from a sensor;
integrating a deviation of the detection signal inputted during an elapsed predetermined period of time to obtain an integration value;
comparing the integration value with a threshold value to obtain a comparison signal; and
recognizing whether the fault condition exists based upon the comparison signal.

9. A detection method to detect a fault condition associated with a sensor,
wherein non-fault detection signals output by the sensor include high frequency noise components, the method comprising:
receiving a detection signal from a sensor;
determining if the detection signal includes components in significant amounts corresponding to the non-fault high frequency noise components; and
outputting an indication that the fault condition is satisfied if the detection signal does not include components in significant amounts corresponding to the non-fault high frequency noise components.

10. The method according to claim 9, wherein the determining includes:
high pass filtering the detection signal over a range corresponding to the non-fault high frequency noise components in order to produce a filtered signal; and
checking if content of the filtered signal exceeds a threshold value; and
wherein the fault condition is satisfied if the content of the filtered signal exceeds a threshold value.

11. The method according to claim 10, wherein the checking includes:
integrating the filtered signal to produce an integrated signal; and
comparing the integrated signal with the threshold value.

12. The method according to claim 10, wherein the checking further includes:
converting the filtered signal into an absolute value signal;
integrating the absolute value signal to produce an integrated signal; and
comparing the integrated signal with the threshold value.

13. The method according to claim 10, wherein the filtering includes: averaging the detection signal to produce an averaged signal; and
taking a difference between the averaged signal and the detection signal to obtain the filtered signal.

14. The method according to claim 13, wherein the averaged signal represents a median value of the detection signal.
